(19) United States
(12) Patent Application Publication
(10) Pub. No.: US 2019/0250493 A1
(43) Pub. Date: Aug. 15, 2019

(54) LASER LIGHT SOURCE DEVICE AND VIDEO DISPLAY APPARATUS

(71) Applicant: SHARP KABUSHIKI KAISHA, Sakai City (JP)

(72) Inventor: NORIAKI FUJII, Sakai City (JP)

(21) Appl. No.: 16/243,642

(22) Filed: Jan. 9, 2019

(30) Foreign Application Priority Data
Feb. 15, 2018 (JP) 2018-025035

(51) Int. Cl. G03B 21/20; G02B 26/12

(52) U.S. Cl. CPC G03B 21/2033; G02B 26/12; G03B 21/2013

(57) ABSTRACT

A laser light source device includes a plurality of semiconductor laser elements, an optical coupling element that couples together a plurality of laser beams that are emitted from the plurality of semiconductor laser elements, and a plurality of apertures, each provided between a corresponding one of the semiconductor laser elements and the optical coupling element, that correspond to the plurality of semiconductor laser elements, respectively. The plurality of apertures are set so that aperture diameters of the plurality of apertures become smaller as wavelengths of laser beams that pass through the respective apertures become shorter.

### BACKGROUND

### 1. Field

The present disclosure relates to a laser light source device and a video display apparatus including the same.

### 2. Description of the Related Art

A small-sized light source module including semiconductor lasers can be suitably used in a video display apparatus such as a laser projector. Such a light source module becomes useful for a while light source and a full-color display especially by using an outgoing beam obtained by coupling together a red laser beam, a green laser beam, and a blue laser beam. Japanese Patent No. 5923164 discloses a light source module that emits outward a laser beam obtained by coupling together three types of laser beam.

For improvements in color rendering properties and color reproducibility in a light source module that couples a plurality of laser beams for use in a full-color display, high-precision optical axis adjustments and adjustments of the beam sizes of the laser beams are required.

FIG. 5 shows a conventional configuration of a light source module that couples and emits a plurality of laser beams. Conventionally, laser beams emitted from semiconductor laser elements 101R, 101G, and 101B, respectively, are coupled together by an optical coupling element 102 so as to overlap one another on an identical optical axis, and the resulting coupled laser beam is passed through an aperture 103, whereby a beam size adjustment is achieved. That is, in the conventional configuration, commonality of the aperture 103, which adjusts a beam size, among the laser beams is achieved. In a case where such a light source module is used in a laser projector or the like, a coupled laser beam that is emitted from the light source module is passed with a polygon mirror, transmitted through an imaging lens, and projected onto a screen.

However, the conventional configuration is undesirably poor in color reproducibility and resolution due to differences in spot size among the laser beams in each pixel of an image projected onto the screen. A reason for this is that a laser beam with a longer wavelength forms a spot with a larger size on the screen due to a trade-off between the numerical aperture NA of a lens and a laser wavelength with the size of a beam that falls on the imaging lens being the same in condensing the coupled laser beam with the imaging lens. For this reason, as shown in FIG. 6, the red laser beam is largest in spot size with the green laser beam being smaller in spot size than the red laser beam and the blue laser beam being smaller in spot size than the green laser beam.

Further, the conventional configuration in which commonality of the aperture 103 is achieved has the following additional problems:

(a) The optical axis of an optical system of each of the laser beams needs to be aligned with the common aperture 103. This requires stricter precision of an optical system from the semiconductor laser elements 101R, 101G, and 101B to the aperture 103.
(b) Stray light produced by the laser beams needs to be eliminated by the common aperture 103.
(c) In a case where the light source module includes photodetectors 104R, 104G, and 104B that measure laser outputs from the semiconductor laser elements 101R, 101G, and 101B, respectively, there is an inferior correlation between the output of a laser beam that is emitted onto the screen and the amounts of light that are received by the photodetectors 104R, 104G, and 104B (because the laser beams that are received by the photodetectors 104R, 104G, and 104B are outputs having yet to travel through an aperture stop formed by the aperture 103 whereas the laser beam that is emitted onto the screen is an output having traveled through the aperture stop formed by the aperture 103).

It is desirable to provide a laser light source device and a video display apparatus that make it possible to equalize the spot size of each laser beam of a coupled laser beam obtained by coupling together a plurality of laser beams with different wavelengths.

### SUMMARY

According to a first aspect of the disclosure, there is provided a laser light source device including a plurality of semiconductor laser elements, an optical coupling element that couples together a plurality of laser beams that are emitted from the plurality of semiconductor laser elements, and a plurality of apertures, each provided between a corresponding one of the semiconductor laser elements and the optical coupling element, that correspond to the plurality of semiconductor laser elements, respectively. The plurality of apertures are set so that aperture diameters of the plurality of apertures become smaller as wavelengths of laser beams that pass through the respective apertures become shorter.

According to a second aspect of the disclosure, there is provided a video display apparatus including a light source module that emits a coupled laser beam obtained by coupling together a plurality of laser beams with different wavelengths, a scanning section that passes the coupled laser beam, and a projector lens section that condenses and projects the coupled laser beam onto a physical object. The light source module is the laser light source device described above.

### BRIEF DESCRIPTION OF THE DRAWINGS

FIG. 1 is a diagram schematically showing a configuration of a laser light source device according to Embodiment 1;

FIG. 2 is a diagram schematically showing a configuration of a video display apparatus according to Embodiment 1;

FIG. 3 is a diagram schematically showing a configuration of a laser light source device according to Embodiment 2;

FIG. 4 is a diagram schematically showing a configuration of a laser light source device according to Embodiment 3;

FIG. 5 is a diagram schematically showing a configuration of a conventional laser light source device; and

FIG. 6 is a diagram showing the spot sizes of laser beams that are emitted from the conventional laser light source device.

### DESCRIPTION OF THE EMBODIMENTS

### Embodiment 1

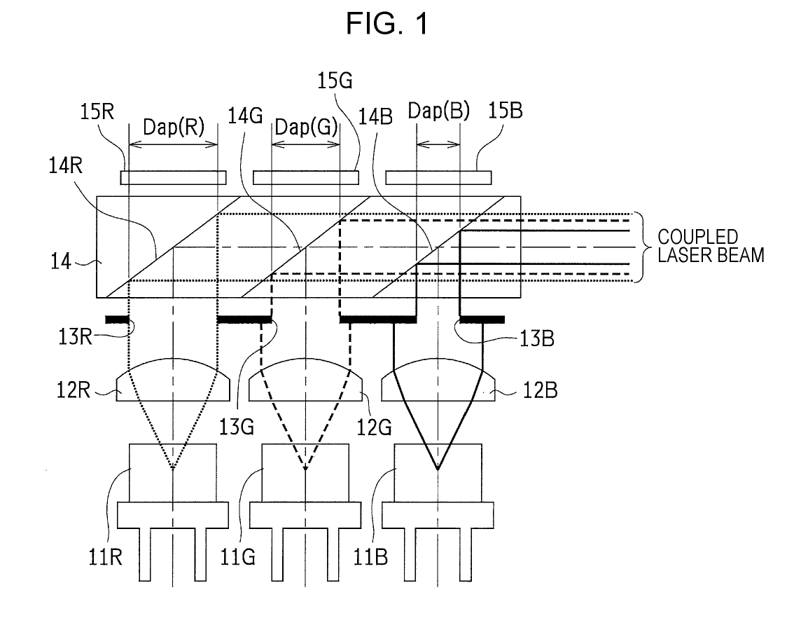

Embodiments of the present disclosure are described in detail below with reference to the drawings. FIG. 1 is a diagram schematically showing a configuration of a laser light source device according to Embodiment 1 (hereinafter referred to as “present laser light source device”).

As shown in FIG. 1, the present laser light source device includes semiconductor laser elements 11R, 11G, and 11B, collimator lenses 12R, 12G, and 12B, apertures 13R, 13G, and 13B, an optical coupling element 14, and photodetectors 15R, 15G, and 15B as constituent elements. These constituent elements are fixedly disposed within a housing (not illustrated), and the housing is provided with an exit window through which to emit a laser beam outward.

The semiconductor laser elements 11R, 11G, and 11B serve to emit, for example, a red laser beam with a wavelength of 650 nm, a green laser beam with a wavelength of 520 nm, and a blue laser beam with a wavelength of 450 nm, respectively. Further, the semiconductor laser elements 11R, 11G, and 11B are arrayed along a straight line so that their respective optical axes are parallel to one another in an identical plane. In Embodiment 1, the semiconductor laser elements 11R, 11G, and 11B are can-type packages having laser elements mounted therein. However, this is not intended to limit the present disclosure. Instead of being can-type packages, the semiconductor laser elements 11R, 11G, and 11B may be framed lasers having laser elements mounted on metal frames or may be so-called open-air laser elements, i.e. unsealed laser elements.

The collimator lenses 12R, 12G, and 12B are disposed on the optical axes of the semiconductor laser elements 11R, 11G, and 11B, respectively, and convert laser beams with angles of radiation into substantially parallel rays.

The apertures 13R, 13G, and 13B are disposed on the optical axes of the semiconductor laser elements 11R, 11G, and 11B, respectively, and disposed downstream of the collimator lenses 12R, 12G, and 12B and upstream of the optical coupling element 14 with respect to the direction in which the laser beams travel. The apertures 13R, 13G, and 13B have different aperture diameters, which will be described later. The apertures 13R, 13G, and 13B may be provided as separate entities or may be provided as an integral molded article.

The optical coupling element 14 serves to produce a coupled laser beam by coupling together the three laser beams that are emitted from the semiconductor laser elements 11R, 11G, and 11B. Specifically, the optical coupling element 14 is constituted by combining three semitransparent mirrors 14R, 14G, and 14B. The semitransparent mirrors 14R, 14G, and 14B are disposed at 45 degrees with respect to the optical axes of the laser beams that fall on them, respectively.

The optical coupling element 14 has three laser inlets that correspond to the semitransparent mirrors 14R, 14G, and 14B, respectively, and one laser outlet through which to emit the coupled laser beam. Furthermore, the optical coupling element 14 may include the after-mentioned three photodetector outlets.

The semitransparent mirror 14R is disposed at a point of intersection between the optical axis of the red laser beam that is emitted from the semiconductor laser element 11R and the optical axis of the coupled laser beam and reflects the red laser beam toward the semitransparent mirror 14G.

The semitransparent mirror 14G is disposed at a point of intersection between the optical axis of the green laser beam that is emitted from the semiconductor laser element 11G and the optical axis of the coupled laser beam. The semitransparent mirror 14G allows the red laser beam coming from the semitransparent mirror 14R to be transmitted toward the semitransparent mirror 14B and reflects the green laser beam toward the semitransparent mirror 14B, thereby coupling together the red laser beam and the green laser beam.

The semitransparent mirror 14B is disposed at a point of intersection between the optical axis of the blue laser beam that is emitted from the semiconductor laser element 11B and the optical axis of the coupled laser beam. The semitransparent mirror 14B allows the red and green laser beams coming from the semitransparent mirror 14G to be transmitted and reflects the blue laser beam, thereby coupling together the red laser beam, the green laser beam, and the blue laser beam. In this way, the coupled laser beam obtained by coupling together the three laser beams is emitted through the laser outlet of the optical coupling element 14.

Alternatively, instead of totally reflecting the red, green, and blue laser beams that fall on the semitransparent mirrors 14R, 14G, and 14B, respectively, the semitransparent mirrors 14R, 14G, and 14B may partially transmit the red, green, and blue laser beams so that the red, green, and blue laser beams partially fall on the photodetectors 15R, 15G, and 15B through the photodetector outlets, respectively. Usable examples of the photodetectors 15R, 15G, and 15B are FMCPs (front monitor photodiodes). The photodetector 15R measures the output of the red laser beam. The photodetector 15G measures the output of the green laser beam. The photodetector 15B measures the output of the blue laser beam. It should be noted that the photodetectors 15R, 15G, and 15B are not essential components of the present disclosure and may be omitted if monitoring of the output of each of the laser beams is unnecessary.

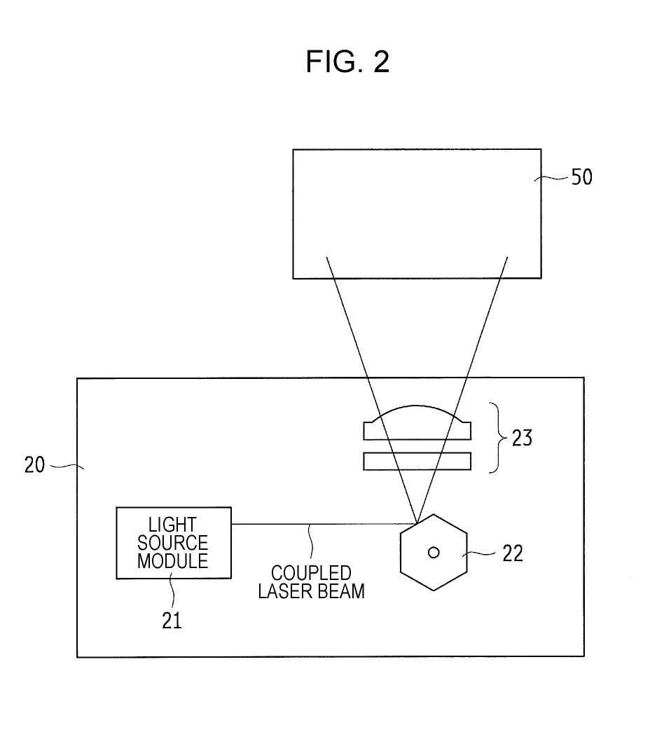

The present laser light source device is a module that is mounted as a light source module in a video display apparatus such as a laser projector. As shown in FIG. 2, such a video display apparatus 20 is constituted by combining a scanning device (scanning section) 22 and a projector lens section 23 with a light source module 21, which is the present laser light source device, and displays an image on a screen (physical object) 50.

The scanning device 22 displays an image or information on the screen 50 by passing a coupled laser beam that is emitted from the light source module 21. A usable example of the scanning device 22 is a known device such as a MEMS (microelectromechanical systems) mirror or a polygon mirror.

The projector lens section 23 forms a beam spot on the screen 50 by condensing the coupled laser beam that is emitted from the light source module 21. It should be noted that the projector lens section 23 does not need to include a plurality of lenses but may only include one lens if it satisfies the required function with one lens.

In FIG. 2, the scanning device 22 and the projector lens section 23 are disposed outside the light source module 21. However, this is not intended to limit the present disclosure. The scanning device 22 may be contained within the light source module 21, or the scanning device 22 and the projector lens section 23 may be contained within the light source module 21.

The following describes the spot size of each of the laser beams in each pixel of an image projected onto the screen 50 by the present laser light source device (light source module 21).

In the present laser light source device, the apertures 13R, 13G, and 13B have different aperture diameters. Therefore, by passing through the apertures 13R, 13G, and 13B, the laser beams have their beam diameters adjusted to coincide with the aperture diameters, respectively.

Note here that, assuming that Dap(R), Dap(G), and Dap(B) are the respective aperture diameters of the apertures 13R, 13G, and 13B and λ(R), λ(G), and λ(B) are the respective wavelengths of the red, green, and blue laser beams, the ratio between the aperture diameters in the present laser light source device is set to satisfy Eq. (1) as follows:

Dap(R):Dap(G):Dap(B)=λ(R):λ(G):λ(B) (1)

That is, the ratio between the aperture diameters is made to coincide with the ratio between the wavelengths of the laser beams that enter the respective apertures.

Further, assuming that f is the focal point of the objective lens, i.e. the projector lens section 23, and Din is the beam diameter of a laser beam that enters the projector lens section 23, the numerical aperture NA is expressed by Eq. (2) as follows:

NA=Din/2f (2)

That is, assuming that laser beams that arrive at the projector lens section 23 through the apertures 13R, 13G, and 13B are parallel rays (i.e. assuming that Dap=Din), a relationship between the respective numerical apertures NA(R), NA(G), and NA(B) of the red, green, and blue laser beams is derived from Eq. (1) and Eq. (2) to be expressed by Eq. (3) as follows:

NA(R):NA(G):NA(B)=λ(R):λ(G):λ(B) (3)

Further, a relationship between the beam diameter ω, light wavelength λ, and numerical aperture NA of a laser beam having passed through the projector lens section 23 is expressed by Eq. (4) as follows:

2ω=2λ/π/NA (4)

Then, from Eq. (3) and Eq. (4), Eq. (5) is derived as follows:

ω(R):ω(G):ω(B)=λ(R)/π/NA(R):λ(G)/π/NA(G):λ(B)/π/NA(B)=1:1:1 (5)

That is, satisfaction of Eq. (1) by the aperture diameters Dap(R), Dap(G), and Dap(B) of the apertures 13R, 13G, and 13B allows the laser beams to form beam spots of equal size on the screen 50.

Thus, instead of using for a coupled laser beam a common aperture that adjusts the beam size of a laser beam, the present laser light source device includes different apertures for each separate laser beam with aperture diameters varying according to the wavelengths of the laser beams. This allows the laser beams to be equal in spot size in each pixel of an image projected onto a screen, bringing about improvements in color reproducibility and resolution in the image projected onto the screen.

Further, since the present laser light source device includes different apertures for each separate laser beam, it eliminates the conventional need to align the optical axis of an optical system of each of the laser beams with a common aperture, requiring less strict precision of an optical system with respect to an aperture.

Further, since the present laser light source device includes different apertures for each separate laser beam, the apertures 13R, 13G, and 13B are disposed in comparative proximity to the semiconductor laser elements 11R, 11G, and 11B, respectively. This allows the apertures 13R, 13G, and 13B to effectively eliminate stray light produced by the laser beams, respectively.

Further, in a case where the present laser light source device includes the photodetectors 15R, 15G, and 15B, laser beams that are received by the photodetectors 15R, 15G, and 15B are light outputs having traveled through aperture stops formed by the apertures 13R, 13G, and 13B, respectively, as with the laser beam that is emitted onto the screen. This improves a correlation between the output of a laser beam that is emitted onto the screen 50 and the amounts of light that are received by the photodetectors 15R, 15G, and 15B. This makes it possible, for example, to improve the precision of corrections or the like that are made to the laser output intensities of the semiconductor laser elements 11R, 11G, and 11B according to detection results yielded by the photodetectors 15R, 15G, and 15B, respectively.

### Embodiment 2

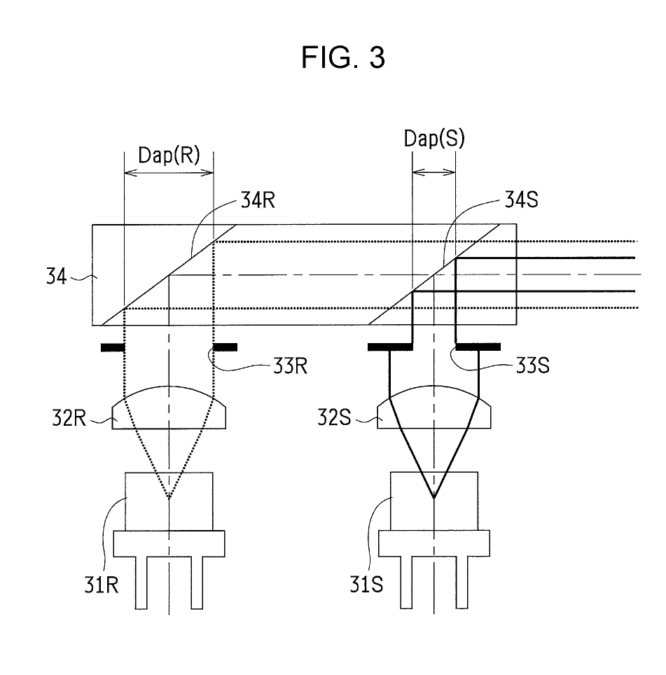

Although Embodiment 1 has illustrated a configuration in which three laser beams with different wavelengths are coupled together, the number of laser beams that are coupled together in the present disclosure is not limited to 3. Embodiment 2 illustrates a case where two laser beams with different wavelengths are coupled together. That is, in Embodiment 2, as shown in FIG. 3, the present laser light source device includes two semiconductor laser elements 31R and 31S. For example, the semiconductor laser element 31R emits a red laser beam with a wavelength of 630 nm, and the semiconductor laser element 31S emits a light blue laser beam with a wavelength of 490 nm.

Further, the present laser light source device includes two collimator lenses 32R and 32S and two apertures 33R and 33S in correspondence with the two semiconductor laser elements 31R and 31S. Furthermore, the present laser light source device includes an optical coupling element 34, and the optical coupling element 34 has semitransparent mirrors 34R and 34S in order to couple together the red laser beam and the light blue laser beam.

In the present laser light source device, too, the ratio between the aperture diameters of the apertures 33R and 33S is made to coincide with the ratio between the wavelengths of the laser beams that enter the apertures 33R and 33S, respectively. That is, the ratio between the aperture diameters of the apertures 33R and 33S satisfies Eq. (6) as indicated below. Assume here that Dap(S) is the aperture diameter of the aperture 33S and λ(S) is the wavelength of the light blue laser beam.

Dap(R):Dap(S)=λ(R):λ(S) (6)

As a result, the present light source device too allows the red laser beam and the light blue laser beam to form beam spots of equal size on a screen.

Furthermore, in the present disclosure, the number of laser beams that are coupled together may be 4 or larger, and for example, it is possible to add still another semiconductor laser element to the laser light source device according to Embodiment 1. For example, a semiconductor laser element that emits an infrared laser beam can be added in addition to the semiconductor laser elements 11R, 11G, and 11B, which emit the red, green, and blue laser beams, respectively. In such a case where still another semiconductor laser element has been added, one collimator lens, one aperture, and one semitransparent mirror are added in correspondence with the semiconductor laser element.

In a case where a semiconductor laser element that emits an infrared laser beam has been added to the laser light source device according to Embodiment 1, a relationship between the ratio between the diameters of the apertures and the ratio between the wavelengths of the laser beams satisfies Eq. (7) as indicated below. Assume here that Dap(IR) is the aperture diameter of the aperture that corresponds to the infrared laser beam and λ(IR) is the wavelength of the infrared laser beam.

Dap(R):Dap(G):Dap(B):Dap(IR)=λ(R):λ(G):λ(B):λ(IR) (7)

### Embodiment 3

Embodiments 1 and 2 have illustrated a configuration in which one semiconductor laser element is provided for a laser beam of one type of wavelength. In other words, although the plurality of semiconductor laser elements of the present laser light source device emit laser beams with different wavelengths, this is not intended to limit the present disclosure. For example, the plurality of semiconductor laser elements of the present laser light source device may include semiconductor laser elements that emit laser beams of the same wavelength.

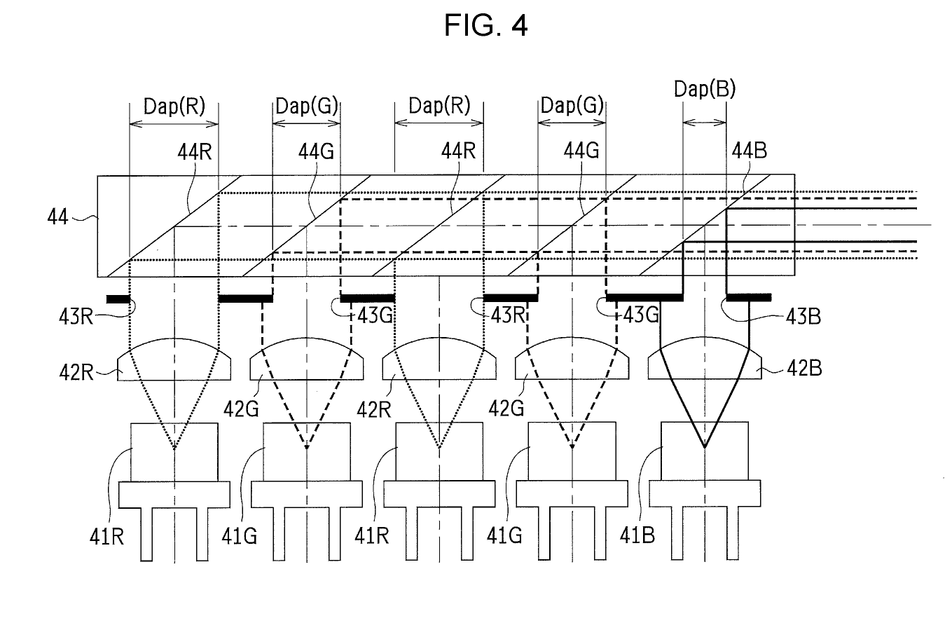

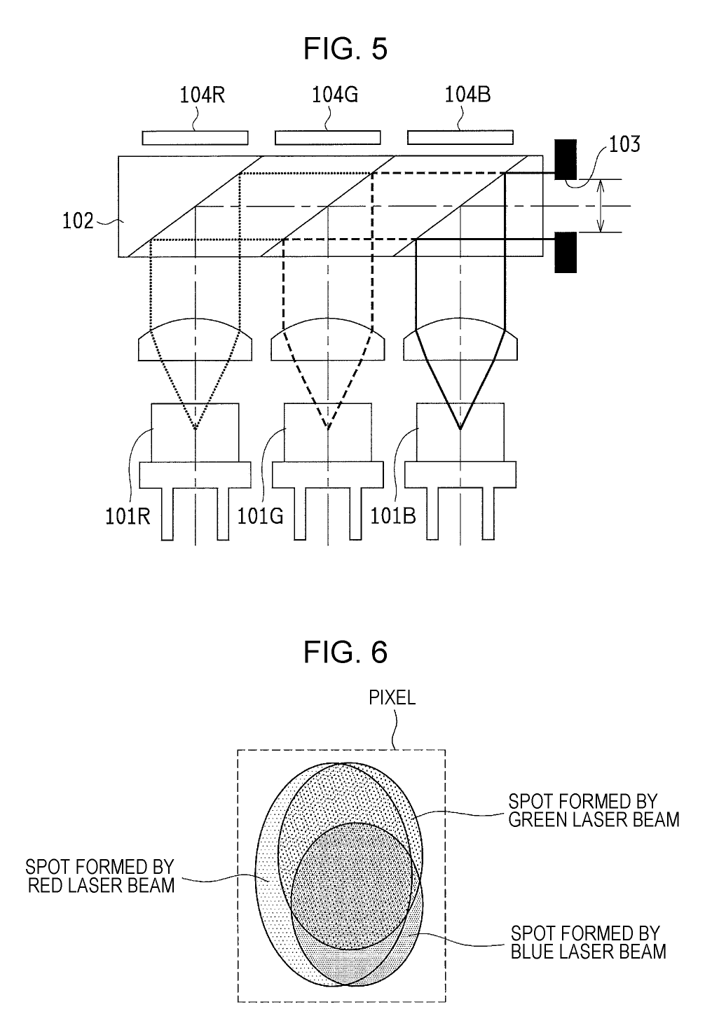

For example, as shown in FIG. 4, the present laser light source device may include five semiconductor laser elements two of which are semiconductor laser elements 41R that emit red laser beams, two of which are semiconductor laser elements 41G that emit green laser beams, and one of which is a semiconductor laser element 41B that emits a blue laser beam. By thus including a plurality of semiconductor laser elements that emit laser beams of the same wavelength, the output of, for example, a red or green laser beam with a low light output can be compensated for.

Further, the present laser light source device includes five collimator lenses, five apertures, and five semitransparent mirrors in correspondence with the number of semiconductor laser elements. That is, two collimator lenses 42R and two apertures 43R are provided in correspondence with the semiconductor laser elements 41R, and an optical coupling element 44 is provided with two semitransparent mirrors 44R. Similarly, two collimator lenses 42G and two apertures 43G are provided in correspondence with the semiconductor laser elements 41G, and the optical coupling element 44 is provided with two semitransparent mirrors 44G. One collimator lens 42B and one aperture 43B are provided in correspondence with the semiconductor laser element 41B, and the optical coupling element 44 is provided with one semitransparent mirror 44B.

In Embodiment 3, too, the ratio between the aperture diameters in the present laser light source device is set to satisfy Eq. (1) as follows:

Dap(R):Dap(G):Dap(B)=λ(R):λ(G):λ(B) (1)

As indicated by Eq. (1), Eq. (6), and Eq. (7), Embodiments 1 to 3 assume that the ratio between the aperture diameters coincides with the ratio between the wavelengths of the laser beams that enter the respective apertures. However, this is not intended to limit the present disclosure.

In a configuration in which the ratio between the aperture diameters is made to coincide with the ratio between the wavelengths of laser beams, the laser beams can be made equal in spot size in each pixel of an image projected onto a screen. This can be said to be a preferred example for bringing about improvements in color reproducibility and resolution in the image projected onto the screen. However, even if the ratio between the aperture diameters does not coincide completely with the ratio between the wavelengths of laser beams that pass through the respective apertures, a configuration in which the aperture diameters become smaller as the wavelengths of the laser beams that enter the respective apertures become shorter makes it possible to reduce variations in spot size among the laser beams in each pixel of an image projected onto a screen, making it possible to bring about improvements in color reproducibility and resolution in the image projected onto the screen. Accordingly, the configuration in which the aperture diameters become smaller as the wavelengths of the laser beams that enter the respective apertures become shorter is encompassed in the technical scope of the present disclosure.

The present disclosure contains subject matter related to that disclosed in Japanese Priority Patent Application JP 2018-025035 filed in the Japan Patent Office on Feb. 15, 2018, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A laser light source device comprising:
a plurality of semiconductor laser elements;
an optical coupling element that couples together a plurality of laser beams that are emitted from the plurality of semiconductor laser elements; and
a plurality of apertures, each provided between a corresponding one of the semiconductor laser elements and the optical coupling element, that correspond to the plurality of semiconductor laser elements, respectively,
wherein the plurality of apertures are set so that aperture diameters of the plurality of apertures become smaller as wavelengths of laser beams that pass through the respective apertures become shorter.

2. The laser light source device according to claim 1, wherein a ratio between the aperture diameters of the plurality of apertures coincides with a ratio between the wavelengths of the laser beams that pass through the respective apertures.

3. The laser light source device according to claim 1, further comprising a plurality of photodetectors provided in correspondence with the semiconductor laser elements, respectively,
wherein the photodetectors are provided in such places as to measure outputs of laser beams having passed through the apertures, respectively.

4. A video display apparatus comprising:
a light source module that emits a coupled laser beam obtained by coupling together a plurality of laser beams with different wavelengths;
a scanning section that passes the coupled laser beam; and
a projector lens section that condenses and projects the coupled laser beam onto a physical object,
wherein the light source module is the laser light source device according to claim 1.
